(19) United States
(12) Patent Application Publication
(10) Pub. No.: US 2004/0178597 A1
(43) Pub. Date: Sep. 16, 2004

(54) Tricyclic scooter

(76) Inventor: Jack Tang, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/414,476

(22) Filed: Apr. 16, 2003

(30) Foreign Application Priority Data
Mar. 10, 2003 (TW) 92203567

(51) Int. Cl. B62M 1/00

(52) U.S. Cl. 280/87.041

(57) ABSTRACT

A tricyclic scooter is composed of a steering post, a handle, a fork, a front wheel, a link assembly, and two treadle assemblies. The handle includes a steering column inserted into the steering post and a gripping portion. The fork to which the front wheel is rotatably connected is positioned at a bottom side of the steering post and connected with the handle. The link assembly is pivotably connected with the post. The two treadle assemblies are connected with the link assembly. While the handle is swung sidewards, the front wheel and the two rear wheels can be driven to lean sidewards by the link assembly. Accordingly, the tricyclic scooter can be propelled not only by feet to travel at high speed but also by swinging the handle sidewards to travel at higher speed.

### BACKGROUND OF THE INVENTION

1. Field of the Invention

The present invention relates generally to exercise equipment, and more particularly to a tricyclic scooter, which is structurally simple and preferably safe for riders.

2. Description of the Related Art

A conventional tricyclic scooter 70, as shown in FIGS. 6-7, is composed of a post 72, a handle 71 fitted in the post 72, a fork 74 positioned at a bottom end of the post 72 and connected with the handle 71, a front wheel 73 rotatably connected with the fork 74 and to be steered by the handle 71, a bridge bar 75 mounted on the post 72, two elongated bars 76 having front ends connected with the post 72 and each disposed with a footboard 77 at a rear end thereof, two rear wheels 78 respectively mounted under the two footboards 77, a pivotable member that has two parallel rods 79 and a sleeve 791 mounted between the two parallel rods 79 and is pivotably connected to the post 72 by a pin 792, the front ends of the two elongated bars 76 being fastened between the two rods 79 and positioned at two sides of the sleeve 791. The conventional tricyclic scooter 70 is operated like a regular skate scooter but dissimilar in steering. While steering the tricyclic scooter 70 to run in other directions, the user holds and drives the handle 71 to lean sidewards along with the post 72. In the meantime, the pivotable member is driven to lift and lower respectively at two ends thereof to drive the two elongated bars 76 to move synchronously at the same angle, thereby causing the scooter to turn stably and to run in other directions.

However, the pivotable member is subject to deformation while undergoing too much strength so as not to drive the two elongated bars to move synchronously while the pivotable member is deformed.

### SUMMARY OF THE INVENTION

The primary objective of the present invention is to provide a tricyclic scooter, which is structurally strengthened and prevented from deformation.

The foregoing objective of the present invention is attained by the tricyclic scooter, which is composed of a steering post, a handle, a fork, a front wheel, a link assembly and two treadle assemblies. The handle includes a steering column inserted into the steering post and a gripping portion. The fork to which the front wheel is rotatably connected is positioned at a bottom side of the steering post and connected with the handle. The link assembly is pivotably connected with the post. The two treadle assemblies include two links connected with the link assembly, two footboards mounted at rear ends of the links, and two rear wheels rotatably mounted under the footboard. While the handle is swung sidewards, the front wheel and the two rear wheels can be driven to lean sidewards by the link assembly. Accordingly, the tricyclic scooter can be propelled not only by feet to travel at high speed but also by swinging the handle sidewards to travel at higher speed meanwhile.

### BRIEF DESCRIPTION OF THE DRAWINGS

FIG. 1 is a side view of a preferred embodiment of the present invention;

FIG. 2 is a top view of the preferred embodiment of the present invention from which a handle is removed;

FIG. 3 is a rear view of the preferred embodiment of the present invention;

FIG. 4 is a schematic view of the preferred embodiment of the present invention in operation;

FIG. 5 is a partial enlarged view of the preferred embodiment of the present invention in operation;

FIG. 6 is a schematic view of a prior art in operation; and

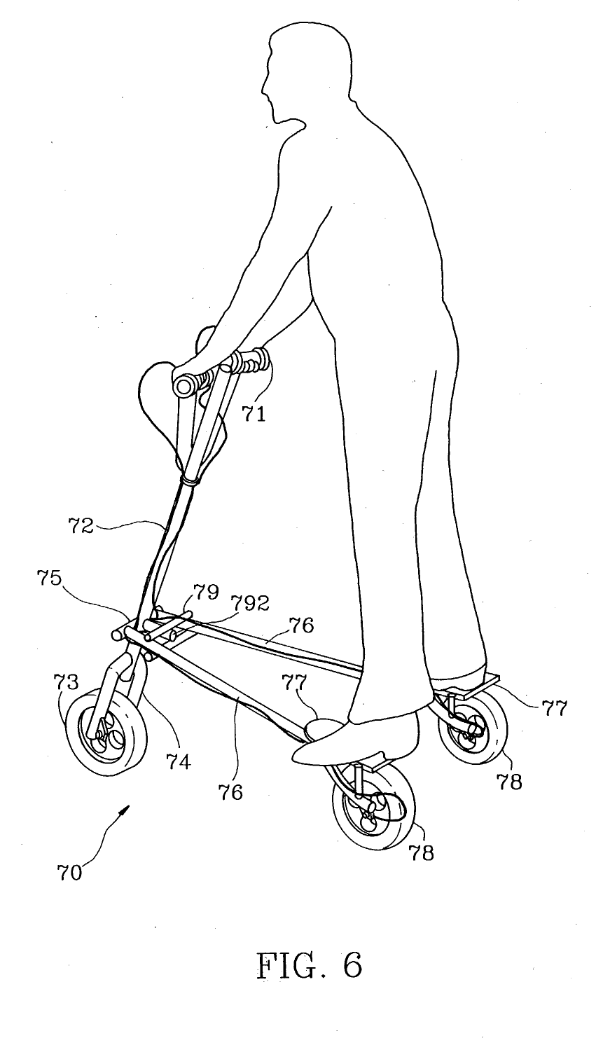

FIG. 7 is a partial exploded view of the prior art.

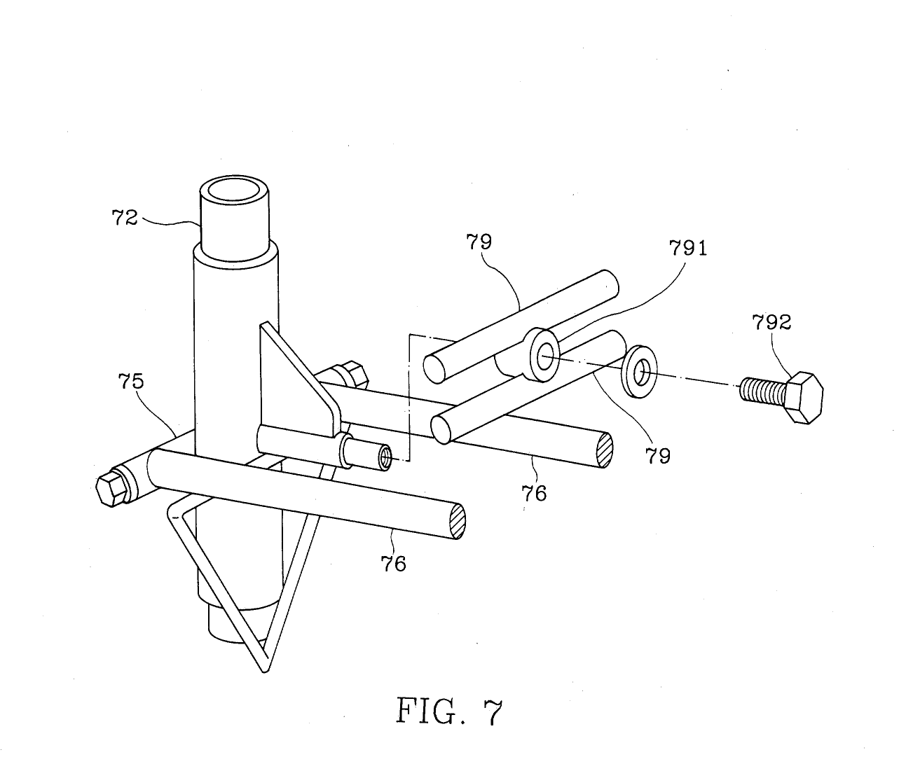

### DETAILED DESCRIPTION OF THE INVENTION

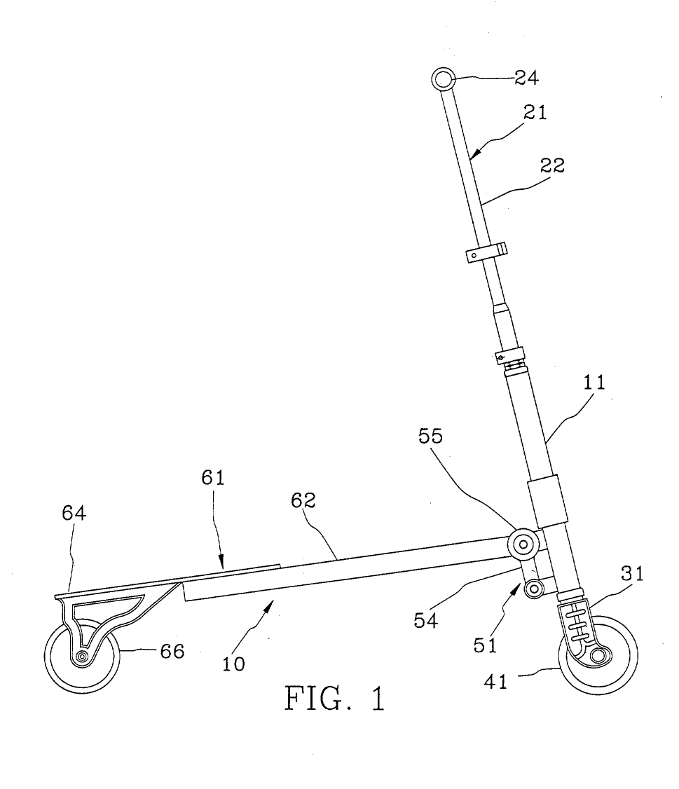

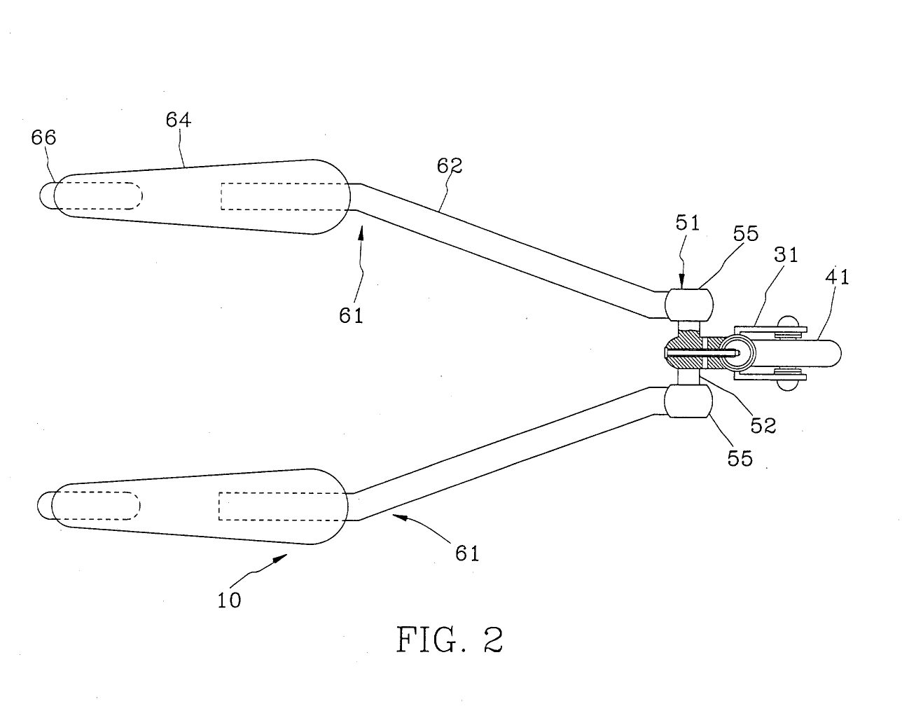

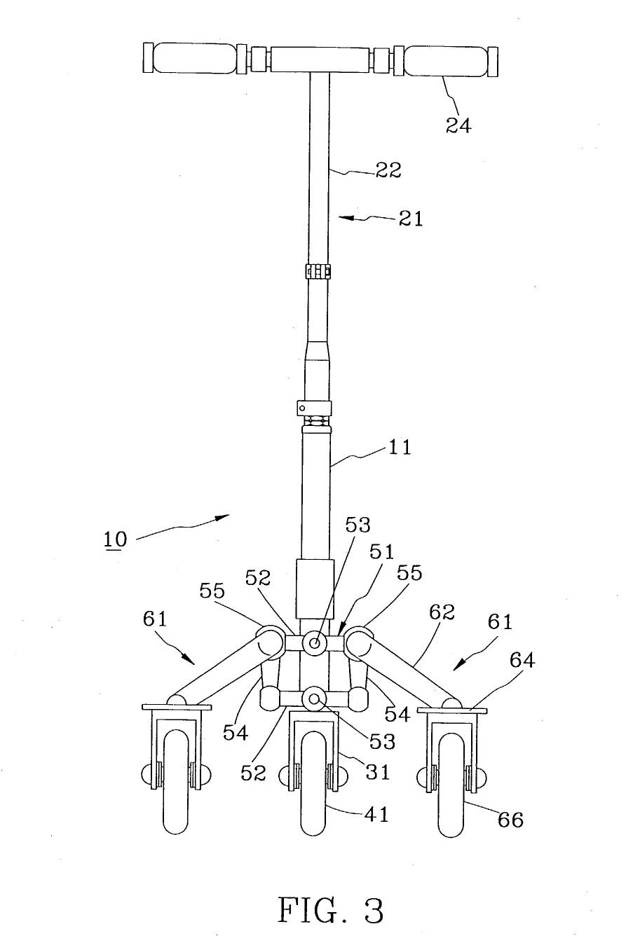

Referring to FIGS. 1-3 and 5, a tricyclic scooter 10 provided by a preferred embodiment of the present invention is composed of a steering post 11, a handle 21, a fork 31, a front wheel 41, a link assembly 51, and two treadle assemblies 61.

The handle 21 includes a steering column 22 inserted into the steering post 11 and a gripping portion 24 extending sidewards from a top end of the steering column 22.

The fork 31 is positioned at a bottom end of the steering post 11 and is connected with the handle 21.

The front wheel 41 is rotatably connected with the fork 31 and can be driven to turn by the handle 21.

The link assembly 51 includes two transversal bars 52, two pivot axles 53, two upright bars 54, and four sleeves 55. The two pivot axles 53 are respectively mounted at the middles of the two transversal bars 52. The two transversal bars 52 are respectively pivotably connected with a bottom end of the steering post 11 by the two pivot axles and positioned parallel to each other and at different elevation. The two upright bars 54 have four sleeves 55 respectively at four ends thereof for fitted and respectively pivotably connected with four ends of the transversal bars 52 respectively by four pins 56. Because each the sleeve 55 has a larger inner diameter than each of the four ends of the two transversal bars 52, a buffer zone 57 is formed inside each of the sleeves 55. Accordingly, the transversal bars 52 and the upright bars 54 can pivot with respect to each other by means of the buffer zone 57.

Each of the two treadle assemblies 61 includes a link 62, a footboard 64, and a rear wheel 66. The two links 62 of the two treadle assemblies are connected with top ends of the two upright bars 54 of the link assembly 51 respectively at two front ends thereof. The footboards 64 are respectively mounted at rear sections of the two links 62. The two rear wheels 66 are respectively rotatably mounted under the two footboards 64.

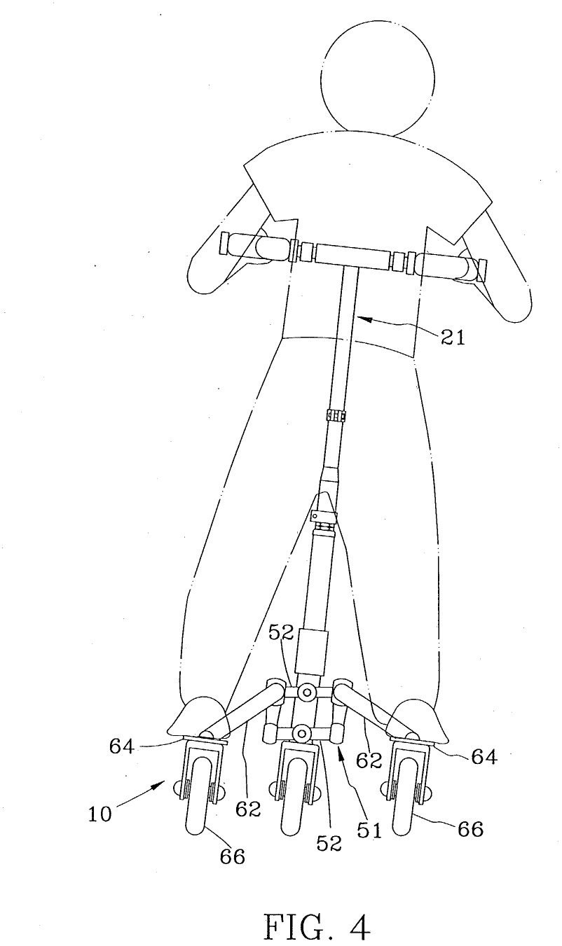

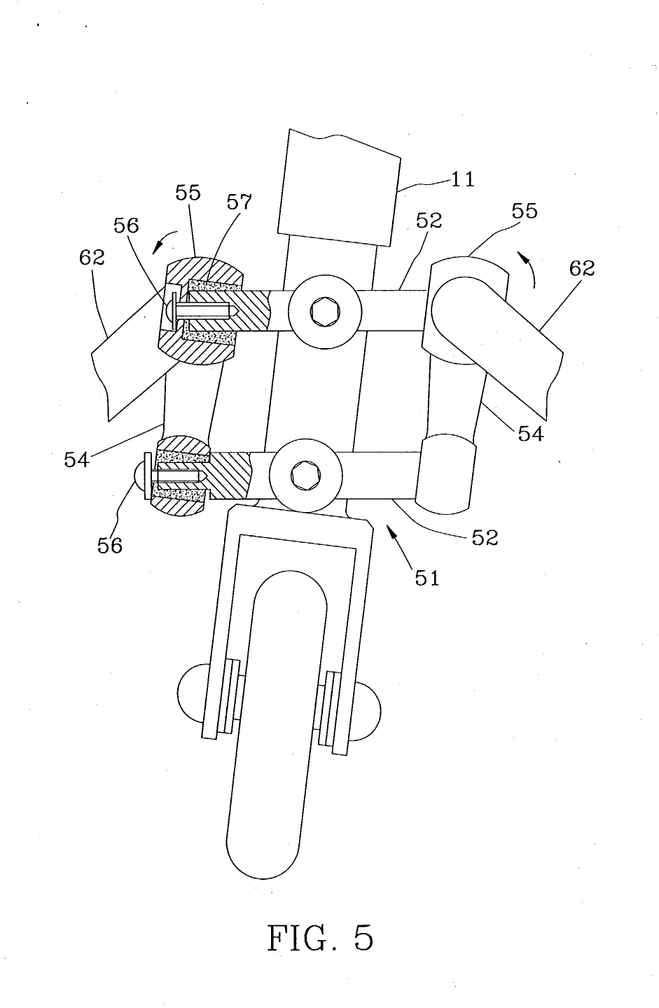

Referring to FIG. 4, while the tricyclic scooter 10 of the present invention is operated, the user holds the handle 21 by hands, stands one foot on one of the two footboards 64, propels the scooter 10 by the other foot pushing contact with the road, and steers the handle 21 to allow the scooter 10 traveling in different directions like the convention scooters. While the scooter 10 travels at a predetermined speed, the user can swing the handle 21 sidewards to permit the two links 62 to drive the two rear wheels 66 via the link assembly 51 to move sidewards, thereby generating more propelling power. As shown in FIG. 5, the handle 21 is swung rightwards; the link assembly is driven by the handle 21 to drive the two links 62 to pivot clockwise slightly; thereby the two rear wheels 66 are driven to lean rightwards. Accordingly, keep swinging the handle 21 leftwards and rightwards repeatedly will drive the two rear wheels 66 to move leftwards and rightwards, such that more and more propelling power is generated to allow the scooter running at higher speed.

Alternatively, the two rear wheels 66 can be mounted under rear ends of the two links 62 and positioned under the two footboards 64.

In conclusion, the tricyclic scooter of the present invention provides the two links 62 that can be driven to move synchronously, and the link assembly that is not only structurally strengthened but also prevented from deformation and malfunction.

What is claimed is:

1. A tricyclic scooter comprising:
a steering post;
a handle having a steering column inserted into said steering post and a gripping portion extending sidewards from a top end of said steering column;
a fork positioned at a bottom end of said steering post and connected with said handle;
a front wheel connected rotatably with said fork and adapted to be driven by said handle to turn;
a link assembly having two transversal bars, two pivot axles respectively mounted on middles of said two transversal bars, and two upright bars, said two transversal bars being positioned parallel to each other and pivotably connected with a bottom section of said steering post by said two pivot axles in different elevation, said two upright bars having distal ends pivotably connected with distal ends of said two transversal bars; and
two treadle assemblies each having a link, a footboard, and a rear wheel, said two links of said two treadle assemblies having two ends connected respectively with said two upright bars of said link assembly, said two footboards of said treadle assemblies being mounted respectively at rear sections of said two links of said treadle assemblies, said two rear wheels being positioned respectively under said two footboards.

2. The tricyclic scooter as defined in claim 1, wherein said two upright bars of said link assembly include four sleeves respectively at four ends thereof for fitted onto four ends of said two transversal bars and pivotably connected with said two transversal bars by four pins, said sleeve having a larger inner diameter than each said transversal bar such that a buffer zone is formed inside each said sleeve for said transversal bars and said upright bars pivoting with respect to each other by said buffer zone.

3. The tricyclic scooter as defined in claim 1, wherein said two links of said treadle assemblies are connected with two top ends of said upright bars of said link assembly at respectively two front ends thereof.

4. The tricyclic scooter as defined in claim 1, wherein said rear wheels are mounted respectively under said two footboards.

5. The tricyclic scooter as defined in claim 1, wherein said two rear wheels are respectively mounted under two rear ends of said two links.
